(19) United States
(12) Patent Application Publication
(10) Pub. No.: US 2009/0309363 A1
(43) Pub. Date: Dec. 17, 2009

(54) Electric wheel

(76) Inventor: Salvatore Rocco Uglietto, Winchester, MA (US)

Correspondence Address: Salvatore R. Uglietto, 42 Mayflower Road, Winchester, MA, 01890, US

(21) Appl. No.: 12/157,582

(22) Filed: Jun. 12, 2008

(51) Int. Cl. F02N 11/04; H02K 47/20; H02K 53/00

(52) U.S. Cl. 290/47; 310/113; 415/916

(57) ABSTRACT

An electrical generating system. A wheel that is eight feet in diameter is turned with a motor that is powered by battery. The battery is charged by a battery charger that supplies power to the battery twenty four hours a day. The size motor needed to turn the wheel will depend on the size of the generator that is needed to supply the electricity to a particular size building. The wheel has a built in shaft in the center of the wheel. The shaft sits on a pair of burring rings that are held up by a steel frame. The wheel can spin freely.

### BACKGROUND OF THE INVENTION

Global warming is a problem many are concerned with. What is needed is a system that can generate electricity more effectively in the case of power failure.

### SUMMARY OF THE INVENTION

A system that will generate electricity within a Home, Office Building, Factory or any Building that is in need of electricity without the fear of storms, hurricanes or any type of thing that can cause power failure.

Most important, it will help with the elimination of global warming. Every state in the union is very concerned.

With a built in electrical system such as this, it will prevent refrigerators from stopping thereby preventing food from spoiling. During the winter season, this system will prevent the loss of heating a home or building, eliminating many large problems.

A system that will generate electricity with the turning of a wheel that is eight feet in diameter. The wheel, while turning, will turn an electrical generator that will produce the electricity that is needed for any particular size building.

### BRIEF DESCRIPTION OF THE DRAWINGS

FIG. 1 shows an electric wheel in accordance with one embodiment of the present invention.

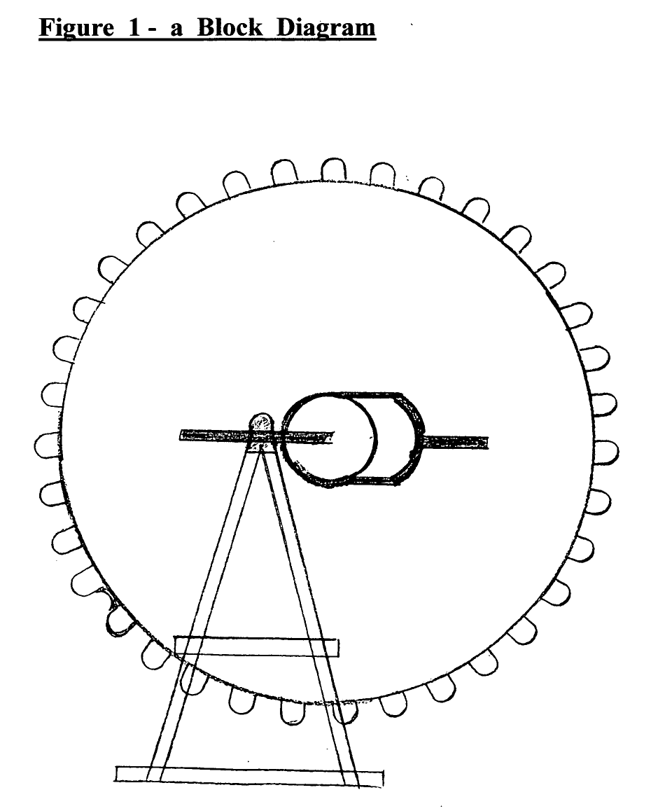

### DETAILED DESCRIPTION OF THE INVENTION

The diameter of the wheel is eight feet in height. The wheel has a built in shaft with burring rings that are greased and are set on a steel frame which will allow the wheel to spin freely by a Battery Powered Motor. The battery is charged by a battery power pack.

The Electrical Generator, being connected to this heavy built wheel, will have the power that is needed to turn the electrical generator and will be set in a position that it will produce the electricity that is needed for that particular building.

It is of course to be understood that the details provided herein, including the measurements, are just examples and that the invention is not limited thereto.

1. Generating Electricity with a Wheel for a Home or where ever necessary.

2. Generating Electricity with Two or more Wheels where ever necessary.

3. A electric wheel comprising:
A) a built-in shaft with burring rings set on a steel frame to enable the wheel to spin freely;
B) a motor for driving the wheel, and
C) an electrical generator connected to the wheel for producing electricity.
